(19) United States
(12) Patent Application Publication
(10) Pub. No.: US 2006/0089736 A1
(43) Pub. Date: Apr. 27, 2006

(54) Music reproducing apparatus, mobile phone conversation apparatus, music reproducing system, and operating method thereof

(75) Inventors: Satoshi Kazuta, Tachikawa-shi (JP); Kiyoshi Hoshino, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/226,386

(22) Filed: Sep. 15, 2005

(30) Foreign Application Priority Data
Sep. 27, 2004 (JP) 2004-280740

(51) Int. Cl. G06F 17/00

(52) U.S. Cl. 700/94

(57) ABSTRACT

A music reproducing apparatus has recording section configured to record in storage region plurality of files, communication section configured to make wireless communication with an external mobile phone conversation apparatus, compressor and de-compressor section configured to compress and decompress this file, reproducing section configured to reproduce the decompressed file, battery section configured to supply power supply electric potential to each section, and control section configured to control each section so as to transmit to the mobile phone conversation apparatus, operational information including folder structure of a plurality of files when authentication process with the mobile phone conversation apparatus is successful, and, when reproducing command having specified one of a plurality of files is received from the mobile phone conversation apparatus, read out and de-compress the file from recording section, and then, reproduce the read out and de-compressed file.

### CROSS-REFERENCE TO RELATED APPLICATIONS

This application is based upon and claims the benefit of priority from prior Japanese Patent Application No. 2004-280740, filed Sep. 27, 2004, the entire contents of which are incorporated herein by reference.

### BACKGROUND OF THE INVENTION

1. Field of the Invention

The present invention relates to an information processing apparatus (music reproducing apparatus) for encoding and decoding digital information and more particularly to an information processing apparatus (music reproducing apparatus), a mobile phone conversation apparatus, an information processing system (music reproducing system, and an operating method thereof, the information processing apparatus being adopted to be operable by the mobile phone conversation apparatus.

2. Description of the Related Art

Recently, with the advancement of digital technology, a number of information processing apparatuses for encoding and decoding digital information have been developed, manufactured, and prevailingly known. Such information processing apparatuses for encoding and decoding digital information are increasingly downsized and are generally used as tools for easily handling digital information.

In such an information processing apparatus, in general, part of a cable such as a headphone is provided as a remote controller unit with a liquid crystal display. By using this remote controller unit, for example, a user can easily make an operation such as music feed even in a commuter train or the like. However, the operation must be made in a state in which connection with a main body is made via a cable. Therefore, there is an aspect that the remote controller unit is hardly operated because the user cannot operate it freely. Recently, music item numbers which can be recorded in an audio player has exponentially increased, and concurrently, information desired to be displayed on a liquid crystal remote controller (or information which should be so displayed) has increased. Thus, there is a need for increasing a liquid crystal display size of a remote controller provided as accessories or reducing a character size. Therefore, in many cases, its operability becomes worse.

On the other hand, in patent document 1 (Jpn. Pat. Appln. KOKAI Publication No. 11-284757), for example, there is shown an example of operating home electronic equipment by using a cellular phone. For example, there is disclosed an example of optically transmitting an operating signal of a VTR (video tape recorder).

However, in patent document 1 introduced as a conventional technique, although there is disclosed that a VTR operating signal is operated by optical transmission, there is no more detailed disclosure. Therefore, for example, there is a problem that, in the information processing apparatus (music reproducing apparatus) according to the present invention, it is impossible to identify how to achieve an operation of specifying and reproducing an arbitrary file from a plurality of (music) files which contained digital information.

### BRIEF SUMMARY OF THE INVENTION

A music reproducing apparatus according to one embodiment of the present invention comprises: a recording section configured to record in a recording region a plurality of files which conform to at least a digital voice file format; a communication section configured to make wireless communication with an external mobile phone conversation apparatus; a compressor and de-compressor section configured to compress and decompress the file recorded by the recording section; a reproducing section configured to reproduce the file de-compressed by the compressor and de-compressor section; a battery section configured to supply a power supply electric potential to at least the recording section, the communication section, the compressor and de-compressor section, and the reproducing section; and a control section configured to control each section to carry out an authenticating process together with the mobile phone conversation apparatus by means of the communication section; when the authentication process is successful, transmit to the mobile phone conversation apparatus via the communication section, operational information including a folder structure of the plurality of files; and then, when a reproducing command having specified one of the plurality of files is received from the mobile phone conversation apparatus, read out the file from the recording section, decompress the file by means the compressor and de-compressor section, and reproduce the decompressed file by means of the reproducing section.

### BRIEF DESCRIPTION OF THE SEVERAL VIEWS OF THE DRAWING

FIG. 1 is a block diagram depicting an example of a configuration of an information processing apparatus according to an embodiment of the present invention;

FIG. 2 is an external view showing an example of an operating switch of the information processing apparatus according to an embodiment of the present invention;

FIG. 3 is an external view showing an example of the information processing apparatus according to an embodiment of the present invention;

FIG. 4 is a block diagram depicting an example of a configuration of a mobile phone conversation apparatus for providing an operating signal to the information processing apparatus according to an embodiment of the present invention;

FIG. 5 is a system diagram depicting an example of a relationship between the information processing apparatus according to an embodiment of the present invention and the mobile phone conversation apparatus or a server device;

FIG. 6 is a system diagram showing an example of a folder structure of audio data contained in the information processing apparatus according to an embodiment of the present invention;

FIG. 7 is an illustrative view illustrating an example of a display screen (displaying all switches) in the mobile phone conversation apparatus for making an operation of the information processing apparatus according to an embodiment of the present invention;

FIG. 8 is an illustrative view illustrating an example of a display screen (displaying switch 1) in the mobile phone conversation apparatus for making an operation of the information processing apparatus according to an embodiment of the present invention;

FIG. 9 is an illustrative view illustrating an example of a display screen (displaying switch 2) in the mobile phone conversation apparatus for making an operation of the information processing apparatus according to an embodiment of the present invention;

FIG. 10 is an illustrative view illustrating an example of a display screen (displaying switch 3) in the mobile phone conversation apparatus for making an operation of the information processing apparatus according to an embodiment of the present invention;

FIG. 11 is an illustrative view illustrating an example of a display screen (displaying switch 4) in the mobile phone conversation apparatus for making an operation of the information processing apparatus according to an embodiment of the present invention;

FIG. 12 is an illustrative view illustrating an example of a display screen (displaying switch 5) in the mobile phone conversation apparatus for making an operation of the information processing apparatus according to an embodiment of the present invention;

FIG. 13 is an illustrative view illustrating an example of a display screen (displaying switch 6) in the mobile phone conversation apparatus for making an operation of the information processing apparatus according to an embodiment of the present invention;

FIG. 14 is an illustrative view illustrating an example of a display screen (displaying no switch) in the mobile phone conversation apparatus for making an operation of the information processing apparatus according to an embodiment of the present invention;

FIG. 15 is an illustrative view illustrating an example of a display screen (tree) in a mobile phone conversation apparatus for operating the information processing apparatus according to an embodiment of the present invention;

FIG. 16 is a flow chart showing an example of an operation (music selection or reproduction) when the mobile phone conversation apparatus makes an operation of the information processing apparatus according to an embodiment of the present invention;

FIG. 17 is a flow chart showing an example of an operation (music selection, acquisition of lyrics, or reproduction) when the mobile phone conversation apparatus makes an operation of the information processing apparatus according to an embodiment of the present invention;

FIG. 18 is a flow chart showing an example of an operation (mix mode operation) when the mobile phone conversation apparatus makes an operation of the information processing apparatus according to an embodiment of the present invention; and

FIG. 19 shows an example of a supported command table between the information processing apparatus according to an embodiment of the present invention and a communication protocol (Bluetooth) mobile phone conversation apparatus.

### DETAILED DESCRIPTION OF THE INVENTION

Hereinafter, embodiments of the present invention will be described in detail with reference to the accompanying drawings. A music reproducing apparatus according to the present invention is introduced as mainly handling a music file. A general information file is handled as an object to be processed without being limited to the music file. Therefore, the present invention discloses an invention relating to an information processing apparatus and an information processing system. Now, embodiments will be described while focusing on a voice file in particular.

<Information Processing Apparatus According to an Embodiment of the Present Invention>

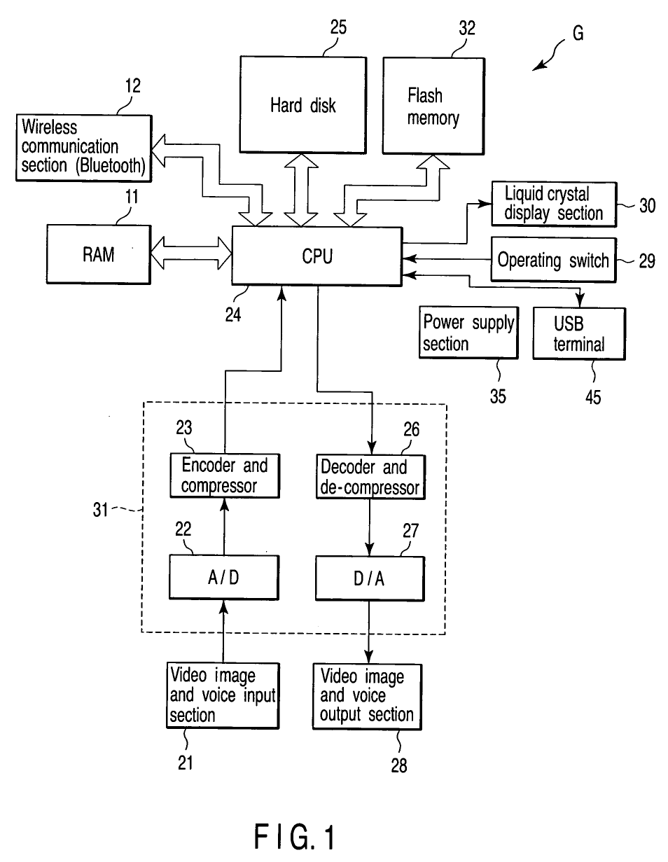

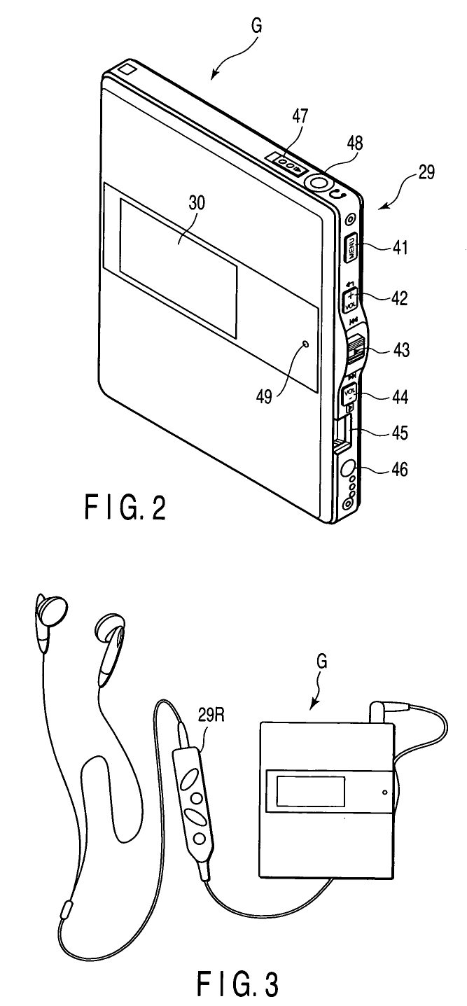

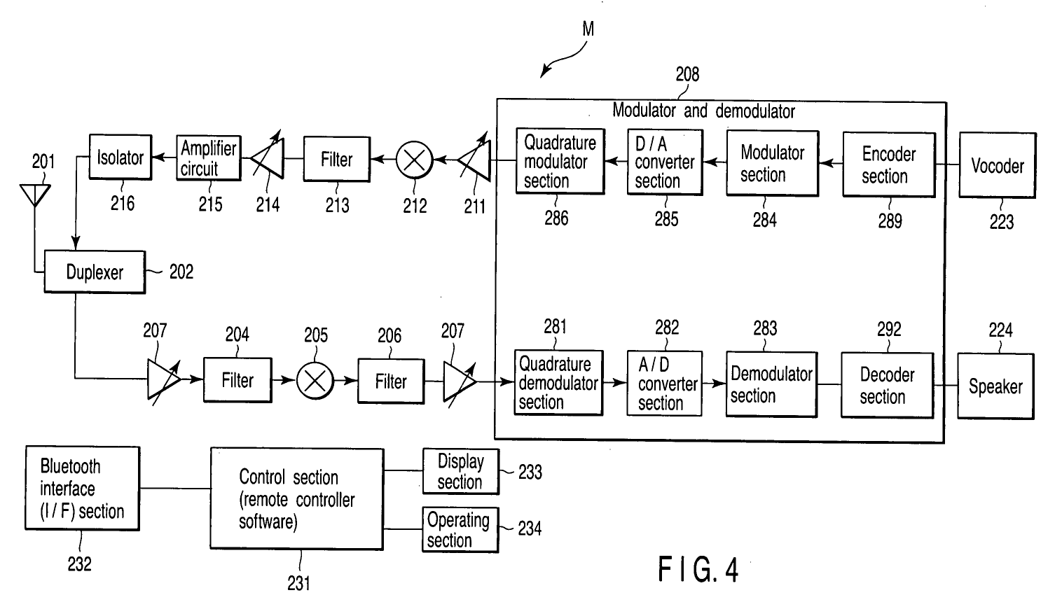

Hereinafter, an information processing apparatus according to an embodiment of the present invention will be described in detail with reference to the accompanying drawings. FIG. 1 is a block diagram depicting an example of a configuration of an information processing apparatus according to an embodiment of the present invention. FIG. 2 is an external view showing an example of an operating switch of the information processing apparatus according to an embodiment of the present invention. FIG. 3 is an external view showing an example of the information processing apparatus similarly.

In FIG. 1, an information processing apparatus G has: a video image and voice processing integrated element 31 connected to a video image and voice input section 21 and a video image and voice output section 28; a CPU 24 which is a central processing unit connected to the element 31 and which is a control section; a RAM 11 which is a storage region connected to the CPU 24; a hard disk 25 connected to the CPU 24 similarly; a flash memory 32 which is a storage region connected to, and incorporated in, the CPU 24 similarly; a liquid crystal display section 30 for displaying an operating information or the like, the display section being connected to the CPU 24 similarly; an operating switch 29 connected to the CPU 24 similarly; a USB terminal 45; and a power supply section 35.

What is connected to a microprocessor 24 are: an operating switch 29 having operating input switches such as voice recording or video image recording, voice or video image reproduction, or operating power OFF of this information processing apparatus G; and a liquid crystal display section 39 indicating an operating state of the information processing apparatus G in response to the input from the operating switch 29.

In addition, an A/D circuit 22, an encoder and compressor circuit 23, a decoder and de-compressor circuit 25; and a D/A circuit 27 each are composed of a one-chip video image and voice processing integrated element (hereinafter, referred to as a video image and voice processing IC) 31.

In addition, the information processing unit G further has a wireless communication section 12 which is an interface for short distance wireless communication such as Bluetooth, for example, the interface being connected to the CPU 24. The word “Bluetooth” used here denotes an interface specification for wireless communication of a short distance, for example, about 10 m. In this specification, a maximum communication speed is 1 Megabit per second, and a frequency of 2.4 GHz is used, the frequency being equal to that used in the IEEE 802.11b system wireless LAN.

In addition, the wireless communication section 12 may make similar short distance wireless communication without being limited to the Bluetooth. For example, a UWB specification, an infrared-ray communication specification, or a wireless LAN (IEEE 802.11) specification and the like is preferred without being limited thereto.

Further, in FIG. 2, the information processing apparatus G has a variety of operating switches 29. These switches include: a menu button 41 for calling a menu screen when setting a variety of operational settings or the like; volume switches 41, 44; a jog switch 43 for making an operation such as fast feed, rewinding, or cue; a USB terminal 45; an AC adapter jack 46; a hold switch 47; a headphone jack 48; and a charge indicator 49 used when a power supply section 35 is a battery charge type.

In such a configuration, the information processing apparatus G which is an information processing apparatus according to the present invention carries out a recording process as described below. That is, a video image and voice input circuit 21 is composed of a microphone for collecting a voice such as music or human voice, acquiring video image information, and generating the acquired information as an analog electrical signal; and an amplifier circuit for amplifying an analog voice signal generated by the microphone or a CCD camera and the like.

The analog video image and voice signal generated by this video image and voice input circuit 21 is converted to a digital video image and voice signal by means of an analog/digital converter circuit (hereinafter, referred to as an A/D circuit) in accordance with operational information provided from the above described operating switches 29 in response to an operating mode basically provided as a default setting. The converted signal is supplied to the encoder and compressor circuit 23. This encoder and compressor circuit 23 encodes the digital video image and voice signal and carries out data compression. Then, predetermined digitally compressed data is generated. For the encoding and compressing operation at this encoder and compressor circuit 23, a compression technique of G729A in accordance with an ITU (International Telecommunication Union) specification is used as an example.

The digitally encoded and compressed data generated by this encoder and compressor circuit 23 is recorded in the hard disk 25 or its incorporated flash memory via the microprocessor 24. This microprocessor 24 is designed to make write and readout controls of the digitally encoded and compressed data in the hard disk 25 or its incorporated flash memory 32 and generate management data for the written digitally encoded and compressed data.

Further, the information processing apparatus G which is an information processing apparatus according to the present invention carries out a reproducing process as described below. In the information processing apparatus G, in accordance with operational information provided from the above described operating switches 29 in response to an operating mode basically provided as a default setting, the digitally encoded and compressed data read out from the hard disk 25 or its incorporated flash memory 32 is de-compressed and decoded as data by means of the decoder and de-compressor circuit 26 under the control of the microprocessor 24. The de-compressed and decoded data is converted to a digital video image and voice signal. The digital video image and voice signal generated by this decoder and de-compressor circuit 26 is converted to an analog video image and voice signal by means of the digital/analog converter circuit (hereinafter, referred to as a D/A circuit) 27. The converted signal is supplied to the video image and voice output circuit 28 composed of an amplifier circuit and a speaker or a display, whereby the reproducing process is carried out.

Furthermore, the information processing apparatus G which is an information processing apparatus according to the present invention can carry out an editing process or the like with reference to the digital data or the like read out from the hard disk 25 or its incorporated flash memory 32 in accordance with operational information provided from the above described operating switches 29 in response to an operating mode basically provided as a default setting. In addition, in these processes, operational information is provided from the operating switches 29 or a remote controller 29R provided at the main body by the user operation. However, as described later, the above operational information may be provided from a cellular phone or a PC via the USB terminal 45 or the wireless communication section 12.

<Mobile Phone Conversation Apparatus According to an Embodiment of the Present Invention>

Now, a mobile phone conversation apparatus configuring an information reproducing system, according to one embodiment of the present invention, will be described with reference to the accompanying drawings. A mobile phone conversation apparatus M has; an antenna 201; a duplexer 202; an RF receiving gain variable amplifier 203; an RF bandwidth limiting filter 204; a frequency converter 205; an IF bandwidth limiting filter 206; an IF receiving gain variable amplifier 207; a modulator and demodulator section 208; an IF transmitting gain variable amplifier 211; a frequency converter 212; an RF bandwidth limiting filter 213; an RF transmitting gain variable amplifier 214; a power amplifier 215; an isolator 216; a vocoder 223; and a speaker 224.

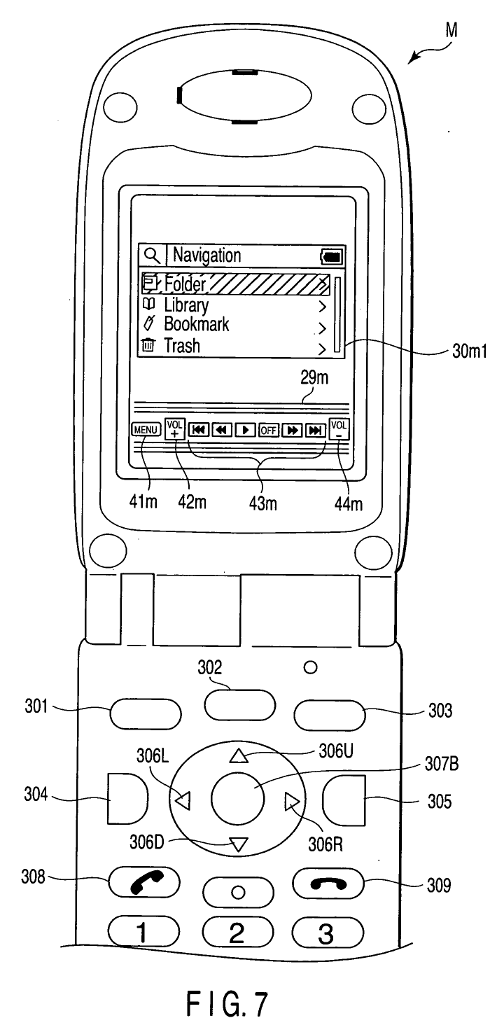

Further, the mobile phone conversation apparatus M has: a control section 231 for controlling a whole operation; a display section 233 connected to this control section, the display section displaying operational information or a photographic image and the like; an operating section 234 having a plurality of switches 301, 302, 303, 304, 305, 306, 307, 308, and 309 or the like, as shown in FIG. 7 to make an operation of this mobile phone conversation apparatus M; and a wireless communication section 232 such as Bluetooth interface (I/F). Although an example of the Bluetooth interface (I/F) is shown as the wireless communication section 232, any interface may be used as long as it can make a similar short distance wireless communication, as is the wireless communication section 12 of the information processing apparatus G. For example, a UWB specification, an infrared-ray communication specification, or a wireless LAN (IEEE 802.11) is preferable without being limited thereto.

In addition, the modulator and demodulator section 208 consists of, for example, a quadrature demodulator section 281; an A/D converter section 282; an information signal demodulator section 283; and a decoder section 292. Further, this modulator and demodulator section is composed of: an encoder section 289 for encoding a signal from a vocoder 223; an information signal modulator section 284; a D/A converter section 285; and a quadrature modulator section 286. In this configuration, a signal quadrature-demodulated by the quadrature demodulator section 281 is A/D-converted by means of the A/D converter section 282. The A/D-converted signal is demodulated as an information signal by means of the signal demodulator section 283. The demodulated signal is outputted after decoded by means of the decoder section 292.

In this configuration, this mobile phone conversation apparatus M carries out a receiving process as described below. A forward link signal transmitted from a base station is received by the antenna 201. Only a component in a receiving signal bandwidth is filtered by means of the duplexer 202. The filtered component is amplified or damped by means of the RF receiving gain variable amplifier 203. An unwanted component is filtered by means of the RF bandwidth limiting filter 204. The filtered component is frequency-converted from an RF band to an IF band by means of the frequency converter 205. An unwanted component is filtered by means of the IF bandwidth limiting filter 206. The filtered component is amplified or damped by means of the IF receiving gain variable amplifier 207. The resulting component is inputted to the modulator and demodulator section 208.

The modulator and demodulator section 208 is composed of, for example, a quadrature demodulator section 281, an A/D converter section 282, an information signal demodulator section 283, an information signal modulator section 284, a D/A converter section 285, and a quadrature modulator section 286.

Here, it is preferable that the encoder section 289 and the decoder section 292 be encoded by common encode key information in order to prevent illegal wiretapping of voice information communicated by an encoding process. However, strictly, it is sufficient if encode key information for encoding from a transmitting mobile phone conversation section and key information relevant to a receiving decoder section 292 are common.

A receiving process of the mobile phone conversation apparatus M having this configuration will be described below. The following operation is carried out under the operational control of the control section 231 in accordance with operational information provided from a user's operating section 234 in response to display of the operational information contained in the display section 233. That is, the signal quadrature-demodulated by the quadrature demodulator section 281 is A/D-converted by means of the A/D converter 282. The A/D-converted signal is demodulated as an information signal by means of the signal demodulator section 283. Further, the thus demodulated signal is decoded by means of the decoder section 292, and the decoded signal is outputted as a voice to the speaker 224.

Furthermore, a transmitting process of this mobile phone conversation apparatus M will be described below. Similarly, the following operation is carried out under the operational control of the control section 231 in accordance with operational information provided from the user's operating section 234 in response to display of the operational information contained in the display section 233. That is, a reverse link signal transmitted from a mobile station is provided by means of the vocoder 223, and the provided signal is encoded by means of the encoder section 289. The thus encoded encode signal is demodulated by means of the information signal modulator section 286, and the demodulated signal is D/A-converted by means of the D/A converter section 285. The thus D/A-converted signal is outputted after modulated by means of the information signal modulator section 284. The D/A-converted signal is quadrature-modulated by means of the quadrature modulator section 286. The quadrature-modulated signal is amplified or damped by means of the IF transmitting gain variable amplifier 211. The resulting signal is frequency-converted from an IF band to an RF band by means of the frequency converter 212. An unwanted component is filtered by means of the RF bandwidth limiting filter 213. The filtered component is amplified or damped by means of the RF transmitting gain variable amplifier 214. The resulting signal is amplified by means of a power amplifier 215. Only a component in the transmitting signal bandwidth is filtered by means of the duplexer 202 via the isolator 216, and the filtered component is spatially transmitted by means of the antenna 201.

By applying such transmitting and receiving processes, it becomes possible to make a connection to the Internet via a base station B. By specifying URL, it is possible to transmit and receive information with respect to a desired server S or the like or to utilize e-mail and the like.

<Operating Method of Information Processing Apparatus Using Mobile Phone Conversation Apparatus M>

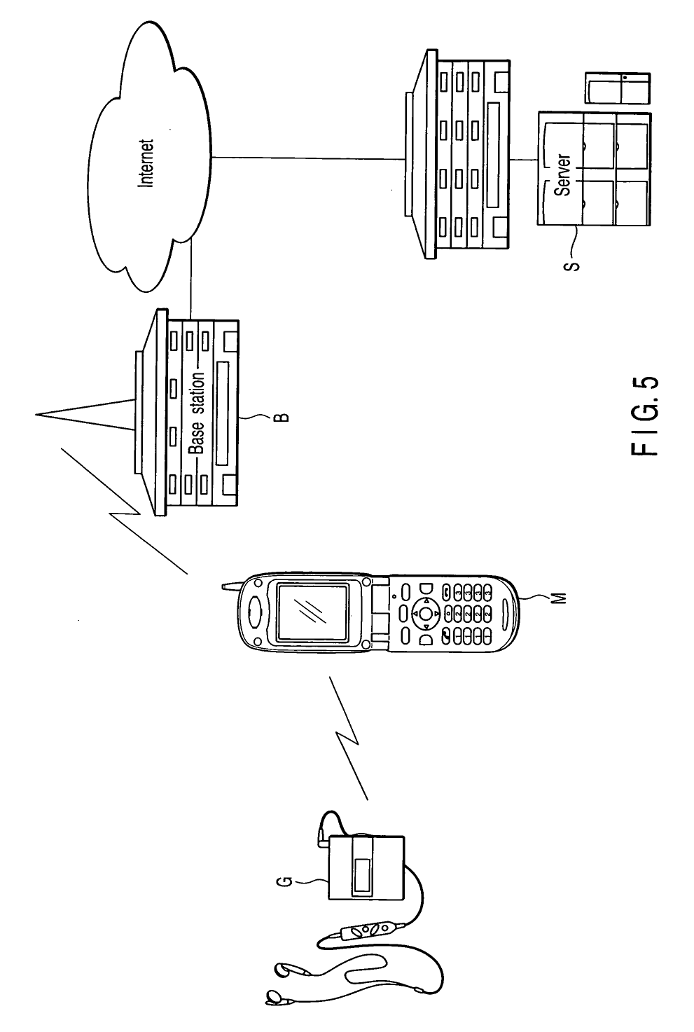

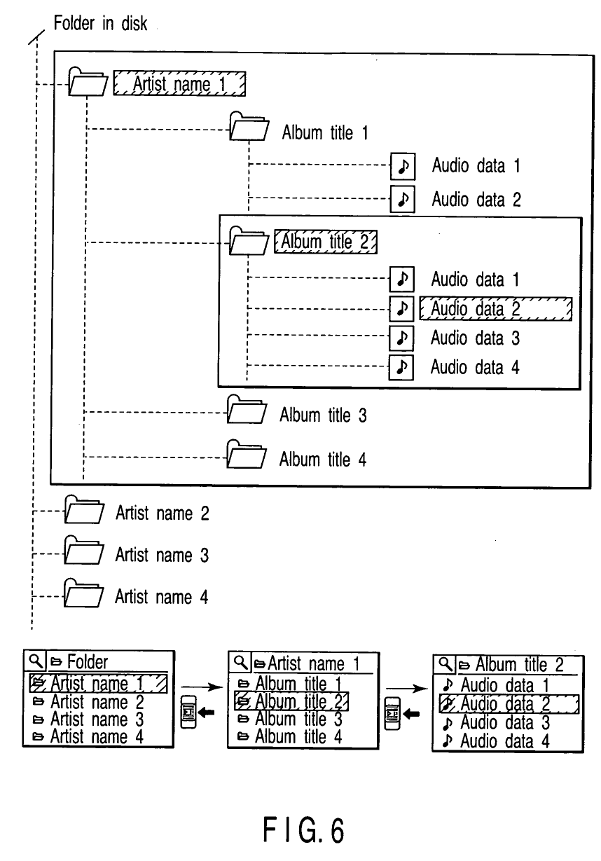

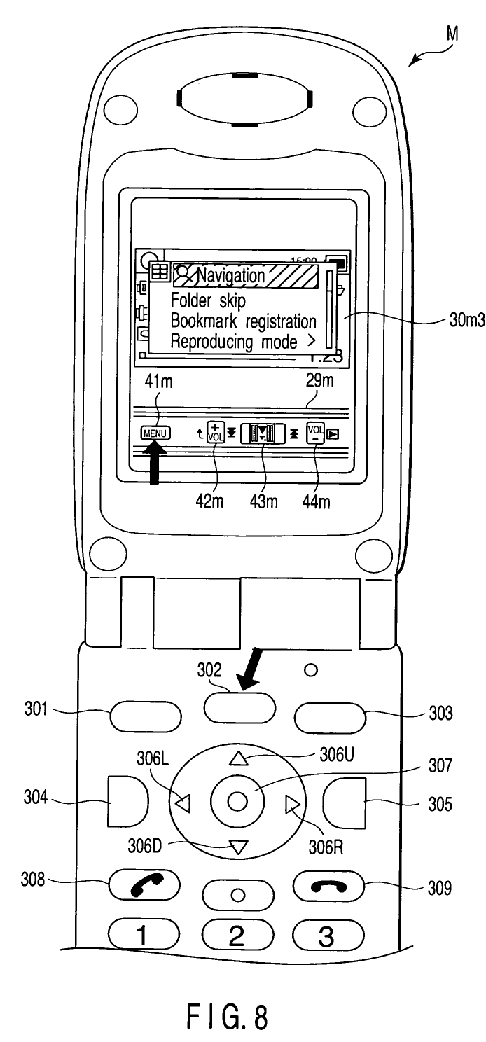

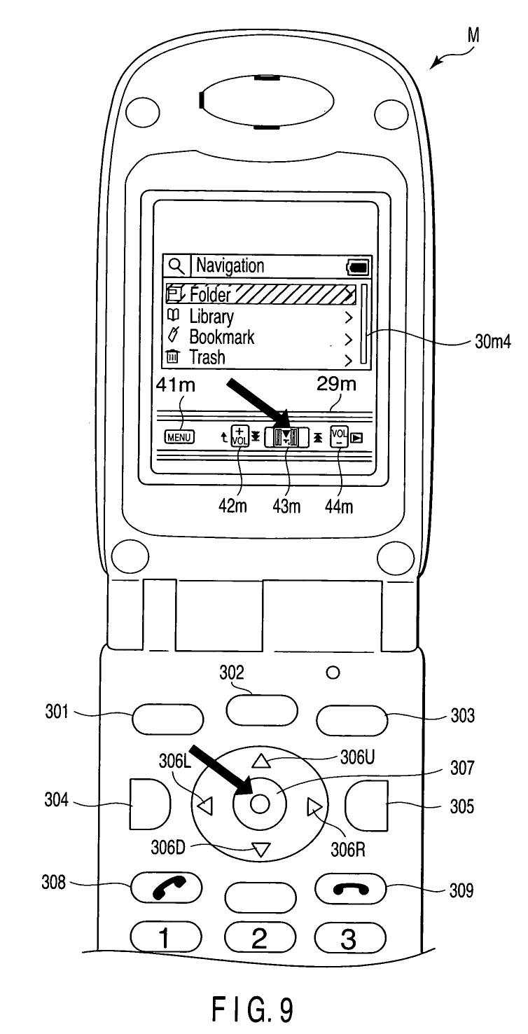

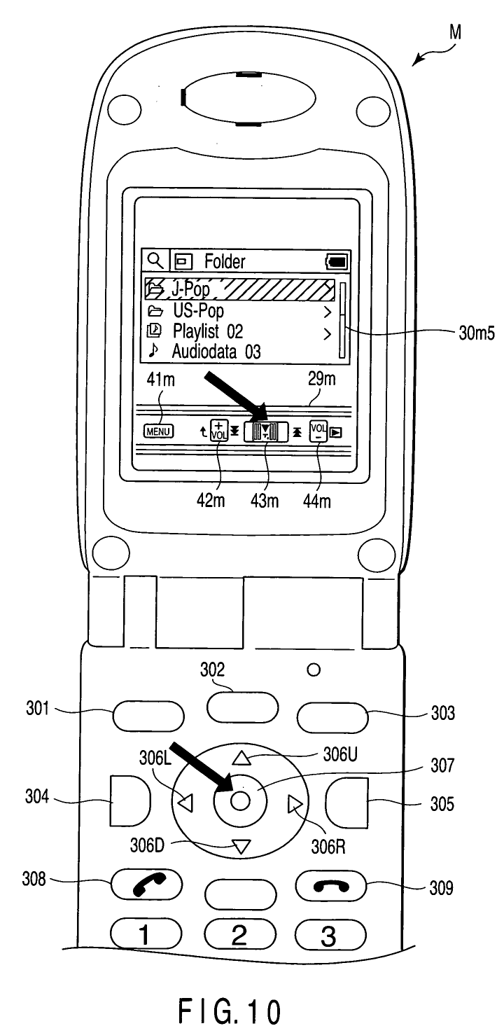

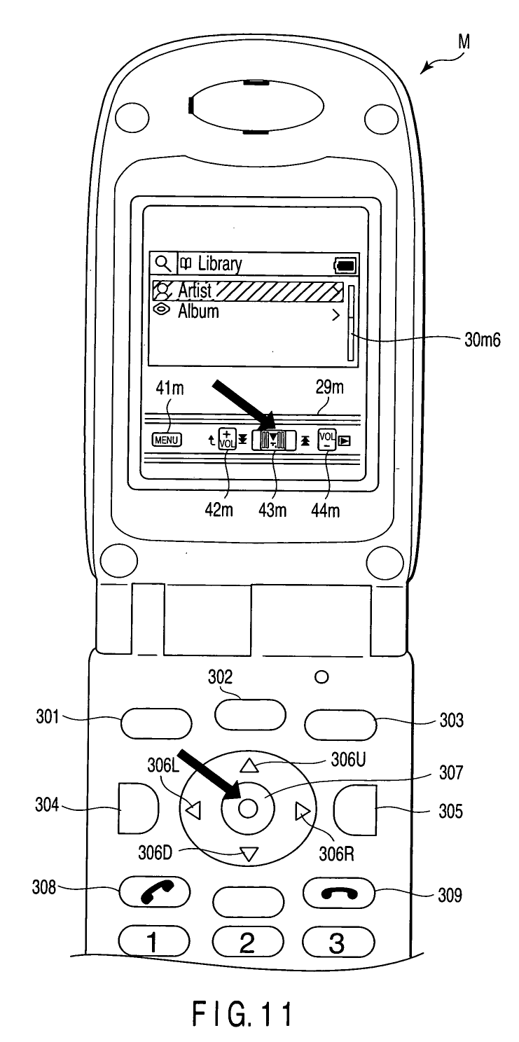

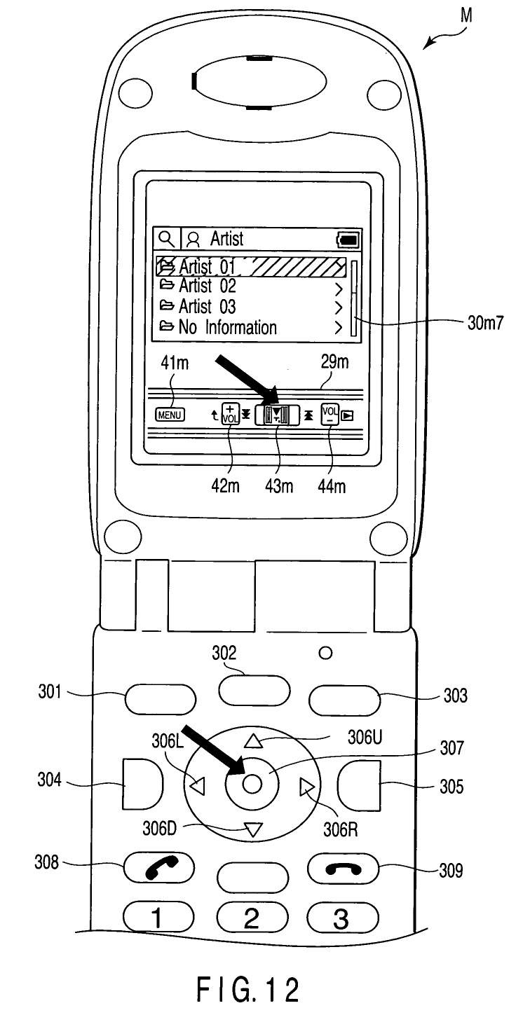

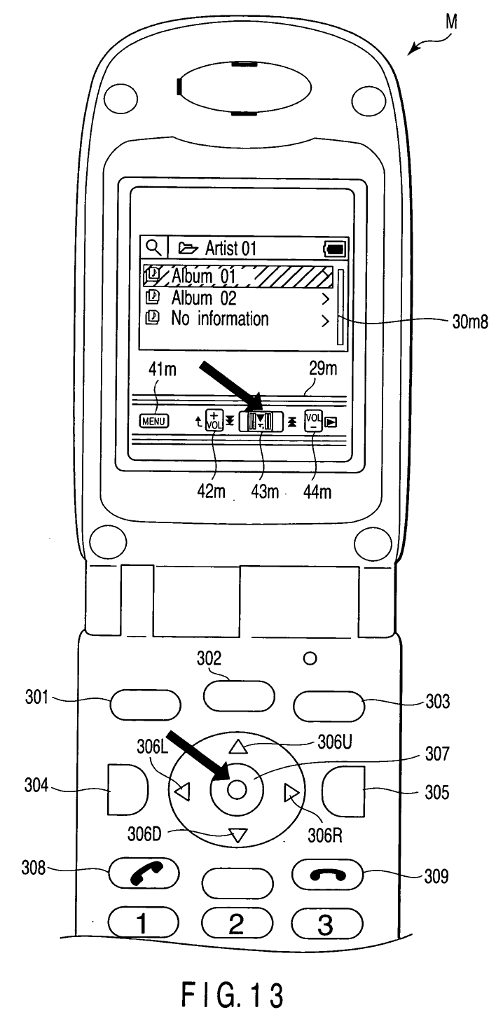

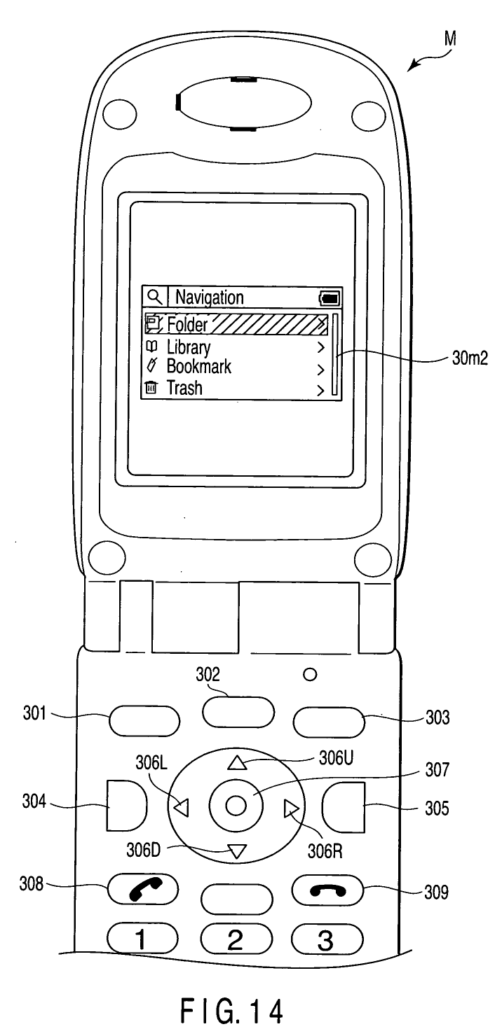

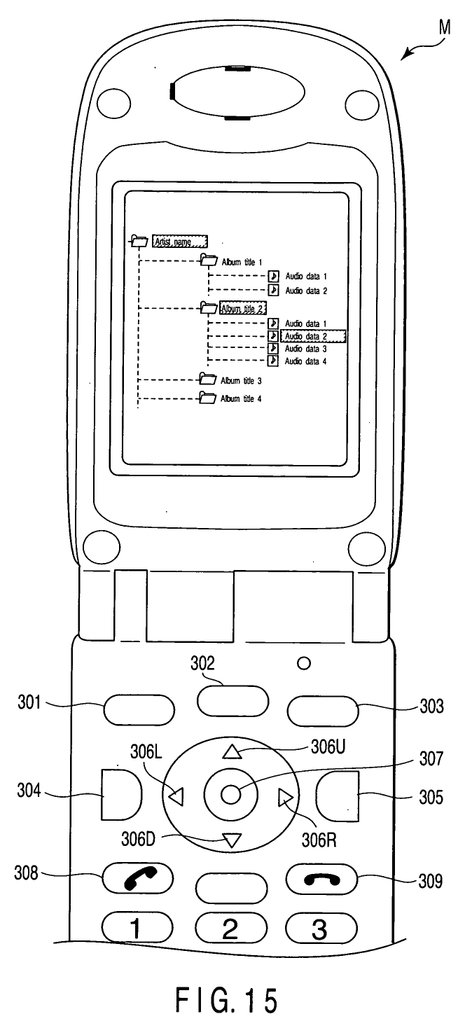

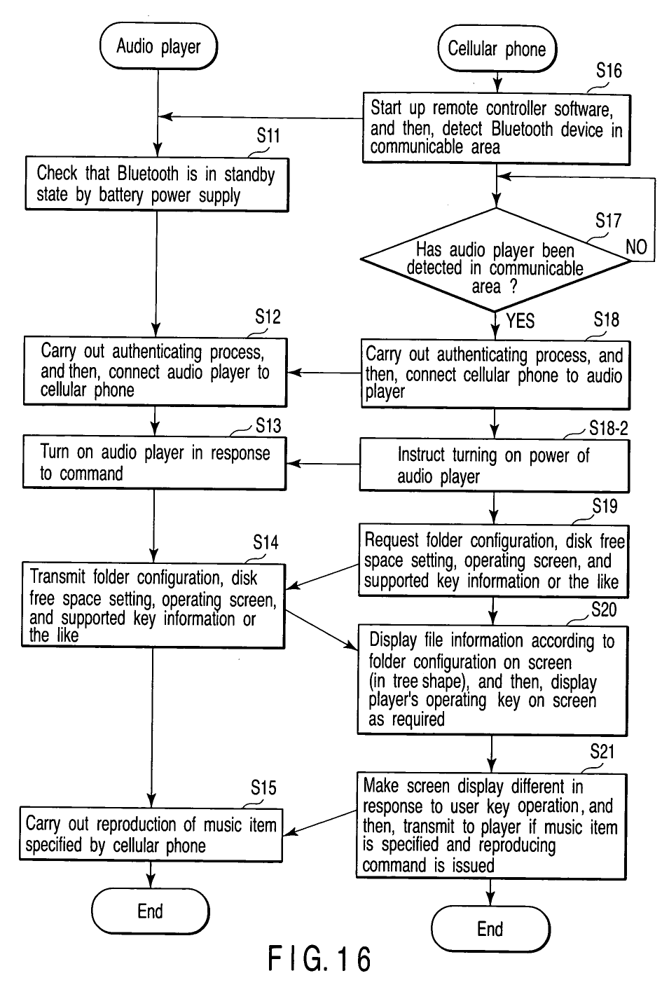

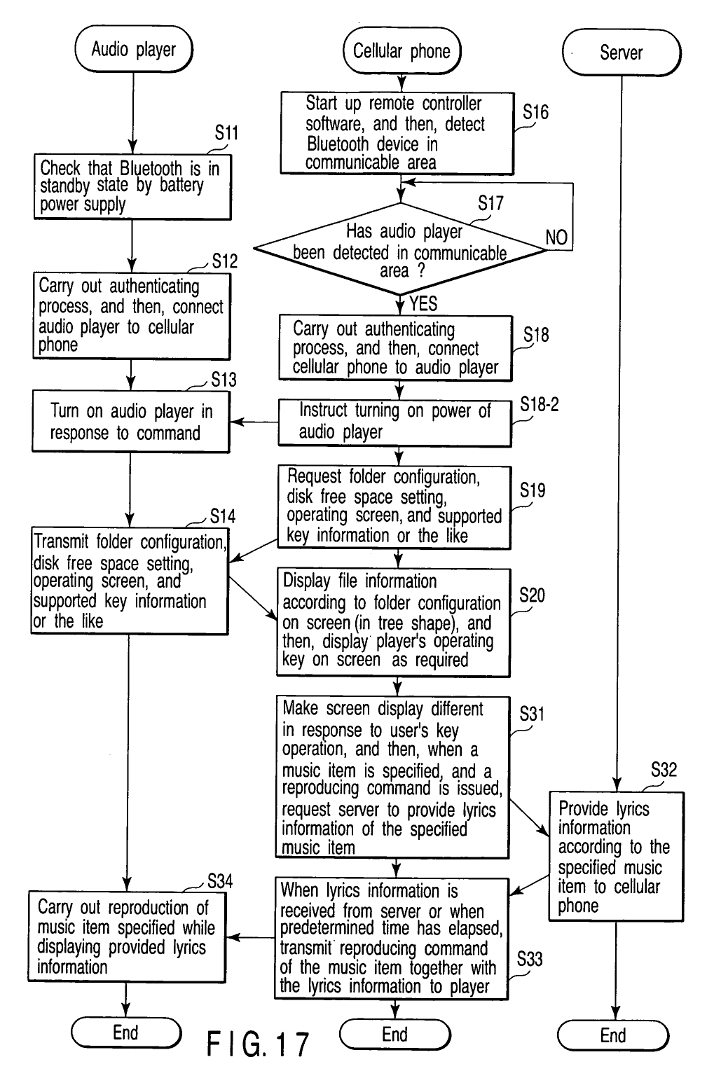

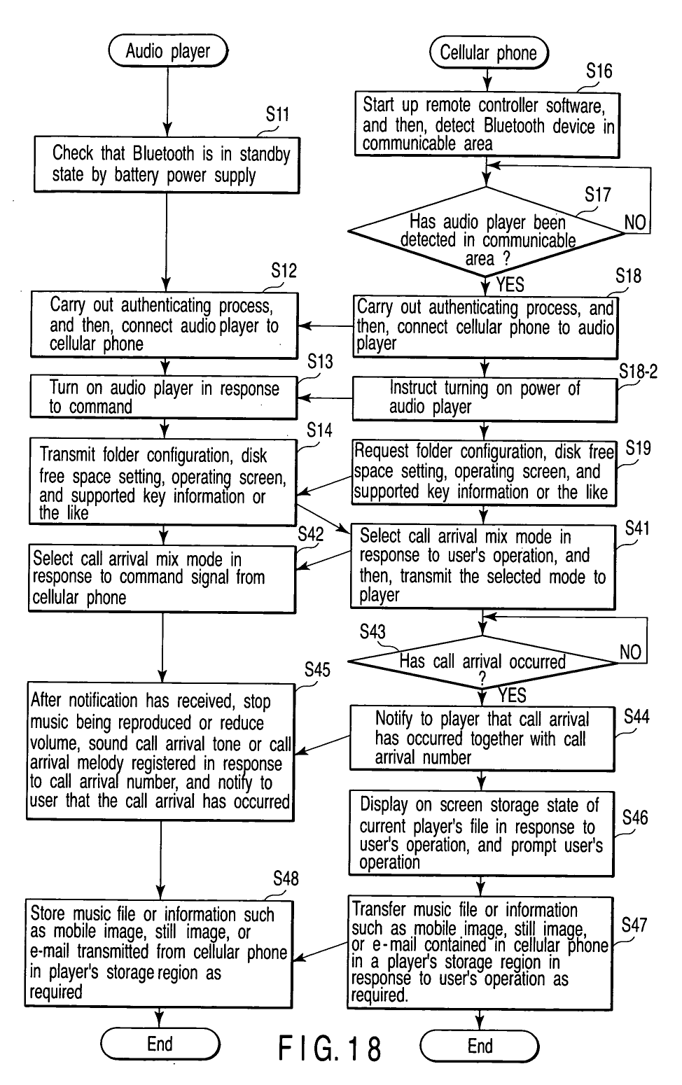

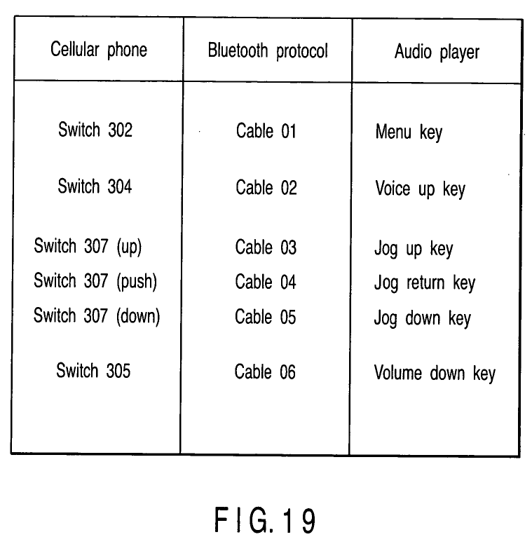

The information processing apparatus G according to an embodiment of the present invention as described above carries out an operating process such as a reproducing process in accordance with operational information supplied from the mobile phone conversation apparatus M, as described below with reference to the accompanying drawings. FIG. 5 is a system diagram showing an example of a relationship between an information processing apparatus according to an embodiment of the present invention and a mobile phone conversation apparatus or a server device; FIG. 6 is an illustrative view illustrating an example of a folder structure of audio data contained in the information processing apparatus similarly; FIG. 7 is an illustrative view illustrating an example of a display screen (displaying all switches) in the mobile phone conversation apparatus for making an operation of the information processing apparatus; FIG. 8 is an illustrative view illustrating an example of a display screen (displaying switch 1) in the mobile phone conversation apparatus; FIG. 9 is an illustrative view illustrating an example of a display screen (displaying switch 2) in the mobile phone conversation apparatus; FIG. 10 is an illustrative view illustrating an example of a display screen (displaying switch 3) in the mobile phone conversation apparatus; FIG. 11 is an illustrative view illustrating an example of a display screen (displaying switch 4) in the mobile phone conversation apparatus; FIG. 12 is an illustrative view illustrating an example of a display screen (displaying switch 5) in the mobile phone conversation apparatus; FIG. 13 is an illustrative view illustrating an example of a display screen (displaying switch 6) in the mobile phone conversation apparatus; FIG. 14 is an illustrative view illustrating an example of a display screen (displaying no switch) in the mobile phone conversation apparatus; FIG. 15 is an illustrative view illustrating an example of a display screen (tree) in a mobile phone conversation apparatus; FIG. 16 is a flow chart showing an example of an operation (music selection or reproduction) when the mobile phone conversation apparatus makes an operation of the information processing apparatus; FIG. 17 is a flow chart showing an example of an operation (music selection, acquisition of lyrics, or reproduction) when the mobile phone conversation apparatus makes an operation of the information processing apparatus; FIG. 18 is a flow chart showing an example of an operation (mix mode operation) when the mobile phone conversation apparatus makes an operation of the information processing apparatus; and FIG. 19 shows an example of a supported command table between the information processing apparatus and a communication protocol (Bluetooth) mobile phone conversation apparatus.

(Basic Operation)

Hereinafter, with reference to a flow chart, a detailed description will be given with respect to a case of operating an information processing apparatus G according to an embodiment of the present invention by means of a mobile phone conversation apparatus. Here, a description will be given with reference to the flow chart of FIG. 5 assuming that the information processing apparatus G is defined as an audio player G and the mobile phone conversation apparatus M is defined as a cellular phone M. The audio player G makes wireless communication with the cellular phone M in accordance with a specification such as Bluetooth by functioning between the CPU 24 and the wireless communication section 12. For example, an operation for reproducing an arbitrary file from a plurality of voice (music) files is made by transmitting operational information such as a folder structure as shown in FIG. 6, for example.

That is, in the flow chart of FIG. 16, first, the audio player G is in a standby state while only the wireless communication section 12 is operated by a power supply section 35 such as a battery, for example, in a state in which power is not turned ON (S11). It is possible to determine whether the wireless communication section 12 is operated independent of turning ON/OFF the main power supply in accordance with specification setting based on a menu 41. In addition, instead of providing the main power supply in particular, it is possible to define a specification such that power is turned ON by operating any operating switch 29 and power is turned OFF if no operation has been made after a predetermined period of time or more has elapsed.

On the other hand, the cellular phone M detects a Bluetooth device in a communicable area by starting up remote controller software which the control section 231 possesses in an operation of the control section 231 (S16). Here, the remote controller software may be provided from the audio player G in accordance with the Bluetooth communication. In addition, as described later, the remote controller software may be supplied from a predetermined server S by connecting the base station B to the server S via the Internet. Here, desired remote controller software can be downloaded by specifying a device type of cellular phone M and a device type of audio player G for the server S. In addition, the remote controller software may be provided from an external terminal of the cellular phone M.

After the cellular phone M has detected the audio player G or the like in a communicable area (S17), when an authenticating process with the audio player G is successful, the cellular phone M is connected to the audio player G (S12, S18). Then, it is preferable that a command for turning ON power be supplied from the cellular phone M (S18-2) and the audio player G be powered ON (S13). Concurrently, the audio player G is powered ON (S12).

Then, the cellular phone M requests the audio player G to provide: a voice file folder configuration and a variety of set values as shown in FIG. 6; an operating key image 29m and operating screen 30m1 as shown in FIG. 7; management information for generating these operating key images 29m and operating screen 30m1 or the like by means of the control section 231 of the cellular phone M, and further, supported key information and the like (S19). Here, the supported key information is provided as an example of correlation information showing a relationship among switches 302, 304, 307 (up), 307 (push), 307 (down), and 305 or the like in the cellular phone M as shown in FIG. 19; code numbers or the like in the Bluetooth protocol; and a menu key 41, a volume up key 42, a jog up key 43, a jog return key 43, a jog down key 43, and a volume down key 44 or the like in the audio player G. Any combination can be provided without being limited to these examples shown in the above figures.

The audio player G, while operating with the CPU 24 and wireless communication section 12, transmits to the cellular phone M: a voice file folder configuration, a disk free space, and a variety of set values as shown in FIG. 6; images 29m and 30m1 for the operating screen as shown in FIG. 7 or management information for generating the images 29m and 30m1 or the like; and further, supported key information as shown in FIG. 19 (S14).

The cellular phone M displays file information according to a folder configuration on a screen in a tree shape, for example, based on the received items of information. Then, it is preferable that a player's operating key image be displayed as required (S20). Then, the user makes a key operation while browsing this display. The control section 231 makes a display to be differentiated in accordance with a key operation (S21). If a voice file is determined in accordance with the user's desired music item, the determined music item is transferred to the audio player G. The audio player G reproduces the music item specified by the cellular phone (S15).

Here, a variety of operations can be displayed as follows in accordance with an operational specification or the like associated with the cellular phone M and the audio player G. Hereinafter, a detailed description of these operations will be given with reference to the accompanying drawings.

In the Case Where an Operating Key Image is Present

The cellular phone M displays file information according to a folder configuration as shown in FIGS. 7 to 15 (in a tree shape) in response to functioning of the control section 231 via a communication section such as the Bluetooth interface (I/F) section 232 in accordance with operational information from the audio player G of step S14. In addition, this cellular phone displays an operating key image 29m of the audio player G on a screen as required (S20). A variety of modes can be provided for a response of the operational information between the cellular phone M and the audio player G. Some of these modes will be described here.

That is, some of these modes will be described in order in response to the operating screen of the cellular phone M. On the operating screen of FIG. 7, the operating key image 29m according to the operating key 29 of the information processing apparatus G of FIG. 2 is shown, and the operating screen 30ml for selecting a voice file is shown.

Here, there is shown a method for carrying out troubleshooting in the case where the cellular phone M does not have any operating key which completely corresponds to the jog switch 43 of the audio player G. Operations of a variety of keys 43m by one jog key such as a cue key, a return key, a reproduce key, a stop key, or a feed key are displayed by a plurality of icons, together with a menu key 41m, a volume up key 42m, and a volume down key 44m contained in the operating key image 29m. The user specifies a predetermined icon by using arrow operating keys 306U, 306D, 306L, and 306R or the like, for example, and returns it by using a center key 307B, whereby an advantageous effect similar to that attained by operating the jog switch 43 of the audio player G can be provided to the audio player G. In addition, with respect to a key other than the jog key as well, the user specifies an icon and returns it, thereby making it possible to carry out a similar operation.

For example, in the case where a correlation between the operating keys of the cellular phone M and those of the audio player G is established as shown in the above described supported command table of FIG. 19, it is preferable that the jog key image 43m be displayed as is the actual jog key 43, as shown in FIG. 8 to FIG. 13. On screens 30m5 to 30m8 on which these operating key images are displayed, an operation is made by the user in accordance with the procedures below.

With reference to FIG. 8, the operating key 302 of the cellular phone M corresponds to the menu key image 41m. By operating this key, for example, a “Navigation” is selected on the operating screen 30m3. Similarly, in FIG. 9, the operating key 307 corresponding to the jog key image 43m. By operating this key, a “folder” is selected from the operating screen 30m4. Similarly, in FIG. 10, the operating key 307 corresponds to the jog key image 43m. By operating this key, for example, a “J. Pop” is selected from the operating screen 30m5. Similarly, in FIG. 11, the operating key 307 corresponds to the jog key image 43. By operating this key, for example, an “Artist” is selected from the operating screen 30m6. Similarly, in FIG. 12, the operating key 307 corresponds to the jog key image 43m. By operating this key, for example, an “Album” can be selected from the operating screen 30m8. In accordance with the above procedures, it becomes possible to easily specify a music item contained in the album to be reproduced by the audio player G with reference to a screen of the cellular phone M.

In the Case Where no Operating Key Image is Present

In the operating screen 30m2 of FIG. 14, the operating key image 29m is not shown, and only the operating screen 30m is shown. This embodiment is provided in the case where a correlation between the operating keys of the cellular phone M and those of the audio player G is established as shown in the above described supported command table of FIG. 19 similarly, and there is no need for an operating key image. On this screen, an operating key image can be displayed to be larger. In this manner, as shown in FIG. 15, it is preferable that all of part of the folder structure (tree structure) of a plurality of voice files be displayed on a screen. Here, for example, the user selects and specifies desired audio data from a plurality of tree-shaped files using the arrow operating keys 306U, 306D, 306L, and 306R, thereby making it possible to issue a reproduce command. Here, it becomes possible to specify an artist name, album title, and an audio name (music title) in this order.

(Applied Operation)

Displaying Lyrics Information

Next, an access is provided from the cellular phone M to the server S via the base station B and the Internet; lyrics information according to a selected music title is acquired; and music is reproduced while the thus acquired information is displayed on the cellular phone M or audio player G.

In the flow chart of FIG. 17, steps S11 and S20 are not described here because these steps are identical to those in the flow chart of FIG. 16. In the cellular phone M, when the user specifies a desired music item from an operating switch and an operating screen in accordance with step S20, the cellular phone M then makes connection to the base station B in response to an operation of the control section 231. Then, the cellular phone requests the server S to provide lyrics information via the Internet with reference to a music title or an artist name and a music item number or the like (S31). In response to this request, the server S samples the corresponding lyrics information or any other related information from an incorporated database with reference to the music title or artist name and music item number or the like, and transmits the information to the cellular phone M (S32).

The cellular phone M receives the lyrics information or any other related information or transmits to the player a command for reproducing this music item together with the lyrics information after a predetermined period of time has elapsed (S33). Alternatively, it is preferable that this lyrics information be displayed on the display screen of the cellular phone M at the same time when the audio player G carries out a reproducing operation. The audio player G carries out reproduction of a specified music item while displaying the provided lyrics information (S34). Alternatively, it is possible to carry out reproduction of a specified voice file similarly without displaying the lyrics information.

Call Arrival Mix Mode/Storage Processing

The cellular phone M and the audio player G are thus linked with each other, thereby enabling another processing operation. For example, it is preferable to prepare an operating mode such as a “call arrival mix mode” and cause the audio player G to notify the user if a call arrival occurs in the cellular phone M after this mode has been selected.

In the flow chart of FIG. 18, steps S11 and S19 are not described here because these steps are identical to those in the flow chart of FIG. 16. In the cellular phone M, after operational information has been provided from the audio player G in accordance with step S14, when the call arrival mix mode is selected in response to the user's operation, this mode is notified to the audio player G (S41). In the audio player G, the call arrival mix mode is selected in response to a command signal from the cellular phone M (S42).

If a call arrival occurs in the cellular phone M (S43), such a call arrival is notified to the player G together with a call arrival number (S44). In the audio player G having received such a notification, music in reproduction is stopped or a volume is reduced. Then, the call arrival is notified to the user by sounding a call arrival tone or a call arrival melody registered according to the call arrival number (S45). That is, in the audio player G, a telephone number and a specific music file are associated with each other in advance, thereby making it possible to notify a call arrival by a number of music items according to telephone directory information.

Further, the cellular phone M and the audio player G are linked with each other, thereby making it possible to utilize the audio player G as a data storage place in a cellular phone having its comparatively small storage capacity.

That is, in the cellular phone M, in accordance with the user's operation, a storage condition such as a folder structure of a voice file or the like in a current audio player G or a disk free space is displayed on a screen, thereby prompting an operation of transferring a variety of data contained in the user's cellular phone M (S46). Here, it is preferable to calculate whether a capacity is large or small in size based on judgment of the control section 231 of the cellular phone M and to display only a file which can be transferred. A file to be transferred, the file being specified by a further user's operation, a music file contained in the cellular phone according to a transfer destination, or information such as a mobile image, still image, or E-mail are transferred to a predetermined storage region of the player as required (S47). On the other hand, in the audio player G, the music file transferred from the cellular phone M or information such as a mobile image, a still image, or E-mail is stored in a storage region at the user specified position such as the hard disk 25 (S48).

In this manner, the information processing apparatus and mobile phone conversation apparatus according to the embodiment of the present invention are combined with each other, thereby making it possible to easily store an E-mail file, a telephone directory file, a music file, an image file, a mobile image file, and an application file or the like which become a burden on a memory or operation. In addition, it becomes possible to make a variety of file operations using a cellular phone in an environment which is similar to that in which a personal computer is used at home.

Further, the audio player G is operated in linkage with the cellular phone M, thereby facilitating connection to the Internet. Thus, it becomes possible to make a variety of operations of achieving a linkage with a music related site, for example. It is known that Gracenote Inc., US (registered trademark) provides services such that a music title or a music item management code and the like can be determined from a waveform of voice information, for example.

With respect to such a site for making a search for a music title, in the case where no information relevant to a file name or a tag is present in functioning of the CPU 24, the audio player G samples a waveform from a voice file without waiting for the user's instruction, and then, records in the hard disk 25 search information to be associated with the voice file contained in a storage region. When the audio player G is connected to the cellular phone M, it is preferable that the player should provide an access to a search site via the cellular phone M without waiting for the user's instruction, detect an unknown music title, and further, change this voice file name to a searched name.

That is, the information processing apparatus (music reproducing apparatus) according to the above described embodiment is a mobile recording and reproducing apparatus comprising a battery section, the apparatus notified to a cellular phone at least a folder structure (tree structure) of a plurality of files conforming to a digital voice file format, the files being recorded in a recording section. Then, the cellular phone displays all or part of a folder structure of a plurality of music files based on the folder structure (tree structure) of the plurality of files, thereby making it possible to facilitate intuitive file selection.

In this manner, for example, in the case where an operation is carried out by remote control unit which partially includes a connection portion of a headphone cable, the cable is connected to a main body of the information processing apparatus (music reproducing apparatus). Thus, free feeling of operation cannot be obtained, and further, a display section cannot be acquired to be large in size. Therefore, the feeling of operation can be extremely improved as compared with a case in which only one title of music can be displayed at most. Further, in response to an operation of E-mail in a commuter train which is generally carried out, it becomes possible to intuitively make an operation of music selection in the information processing apparatus (music reproducing apparatus) in extension of such an operation of a cellular phone. In addition, it becomes possible to achieve easy operability when using an E-mail operation as an operation of selecting a music item for BGM.

In addition, in a cellular phone having a comparatively small storage capacity, an E-mail file, a telephone directory file, a music file, an image file, a mobile image file, and an application file or the like become a burden on a memory or operation. However, in combination with the information processing apparatus (music reproducing apparatus) according to the embodiment of the present invention, this information processing apparatus is used as a device for storing these files, thereby making it possible to carry out a variety of operations using a cellular phone in an environment relevant to a storage capacity, the environment being similar to that in which a personal computer is used at home.

In accordance with a variety of the embodiments described above, the present invention can be carried out by one skilled in the art. Further, a variety of modified examples of these embodiments can be easily conceived by one skilled in the art, and it is possible to apply such modified examples to a variety of embodiments even if one does not have an inventive capability. For example, while the above embodiments have mainly described a voice file or the like, the embodiments of the present invention are applicable to general digital information such as a mobile image file or a database without being limited thereto. Therefore, the present invention encompasses a broad scope without departing from the disclosed principle and novel features without being limited to the above described embodiments.

What is claimed is:

1. A music reproducing apparatus comprising:
a recording section configured to record in a recording region a plurality of files which conform to at least a digital voice file format;
a communication section configured to make wireless communication with an external mobile phone conversation apparatus;
a compressor and de-compressor section configured to compress and decompress the file recorded by the recording section;
a reproducing section configured to reproduce the file de-compressed by the compressor and de-compressor section;
a battery section configured to supply a power supply electric potential to at least the recording section, the communication section, the compressor and de-compressor section, and the reproducing section; and
a control section configured to control each section to carry out an authenticating process together with the mobile phone conversation apparatus by means of the communication section; when the authentication process is successful, transmit to the mobile phone conversation apparatus via the communication section, operational information including a folder structure of the plurality of files; and then, when a reproducing command having specified one of the plurality of files is received from the mobile phone conversation apparatus, read out the file from the recording section, decompress the file by means the compressor and de-compressor section, and reproduce the decompressed file by means of the reproducing section.

2. The music reproducing apparatus according to claim 1, wherein the communication section makes communication with the mobile phone conversation apparatus in accordance with a Bluetooth specification.

3. The music reproducing apparatus according to claim 1, wherein the communication section makes communication with the mobile phone conversation apparatus in accordance with at least one of a UWB specification, an infrared-ray communication specification, and a wireless LAN specification.

4. The music reproducing apparatus according to claim 1, wherein the communication section transmits to the mobile phone conversation apparatus via the communication section a folder structure of a folder which stores each of the plurality of files.

5. The music reproducing apparatus according to claim 1, wherein the communication section transmits to the mobile phone conversation apparatus, free space information contained in a storage region of the recording section.

6. The music reproducing apparatus according to claim 1, wherein the communication section transmits to the mobile phone conversation apparatus via the communication section, image information to be displayed on an operating screen of the mobile screen of the mobile phone conversation apparatus or information required to generate the image information to be displayed on the operating screen.

7. The music reproducing apparatus according to claim 1, further comprising:
an operating section configured to output an operating signal for reproduction of the file in response to operations of a plurality of operating switches, wherein
the communication section transmits to the mobile phone conversation apparatus, image information to be displayed on an operating screen of the mobile phone conversation apparatus which corresponds to a plurality of operating switches of the operating section.

8. The music reproducing apparatus according to claim 1, wherein, when the communication section receives a call arrival signal from the mobile phone conversation apparatus, the control section controls each section so as to cancel reproduction of a file which conforms to a digital voice file format which is currently reproduced or reduce a volume in response to the call arrival signal, and then, notify to a user that a call arrival has occurred by means of a voice or in another method.

9. The music reproducing apparatus according to claim 1, wherein, when the communication section receives a call arrival signal from the mobile phone conversation apparatus and a signal indicating a telephone number of the call arrival, the control section controls each section so as to cancel reproduction of a file which conforms to a digital voice file format which is currently reproduced or reduce a volume in response to the call arrival signal, and then, notify to a user that a call arrival has occurred by means of a voice or in another method.

10. The music reproducing apparatus according to claim 1, wherein, when a predetermined file and a position at which the predetermined file is to be recorded in a folder structure of the plurality of files are transferred from the mobile phone conversation apparatus, the control section records the predetermined file at a specified position of a recording region of the recording section.

11. A mobile phone conversation apparatus comprising:
a phone conversation section configured to transmit and receive a wireless signal to and from a fixed station, thereby making communication with another mobile phone conversation apparatus;
a communication section configured to make communication with an external music reproducing apparatus in a smaller scale communication range than the phone conversation section by means of a wireless signal in a signal mode which is different from the wireless signal of the phone conversation section;
a display section configured to display on a screen an image according to a phone conversation process of the phone conversation section and a communication process of the communication section;
an operating section configured to make operations of the phone conversation process of the phone conversation section and the communication process of the communication section; and
a control section configured to make control so as to display at the display section a plurality of files based on a folder structure of the plurality of files which conform to at least a digital voice file format, the plurality of files being supplied from the music reproducing apparatus and recorded in the recording section of the music reproducing apparatus, and notify to the external music reproducing apparatus that a predetermined processing command of a predetermined file has been issued via the communication section if the predetermined file is specified and the predetermined processing command is issued in response to a user operation of the operating section.

12. The mobile phone conversation apparatus according to claim 11, wherein the communication section makes communication with the external music reproducing apparatus in accordance with at least one of a Bluetooth specification, a UWB specification, an infrared-ray communication specification, and a wireless LAN specification.

13. The mobile phone conversation apparatus according to claim 11, wherein the communication section receives from the music reproducing apparatus at least one of a folder structure of a folder containing the plurality of files; free space information contained in a recording region of a recording section which the music reproducing apparatus has; image information to be displayed on a screen of the display section or information required to generate the image information to be displayed; and image information to be displayed on a screen of the display section, the image information corresponding to a plurality of operating switches which the music reproducing apparatus has.

14. The mobile phone conversation apparatus according to claim 11, wherein, if a call arrival occurs in the phone conversation section, the control section notifies to the external music reproducing apparatus via the communication section a signal indicating that the call arrival has occurred.

15. The mobile phone conversation apparatus according to claim 11, wherein the control section makes control so as to display on the display section a folder structure of a plurality of files recorded in a recording section of the music reproducing apparatus and free space information contained in a recording region of the recording section, the files and information being supplied from the music reproducing apparatus, and transmit to the music reproducing apparatus via the communication section at least one of items of information such as E-mail information telephone directory information, voice information, image information, mobile image information, and a folder structure contained in a storage region which the mobile phone conversation apparatus incorporates to be moved in response to a user operation of the operating section together with positional information which is a move destination in the recording section of the music reproducing apparatus.

16. An information reproducing system having a music reproducing apparatus, a mobile phone conversation apparatus, and a server device, the music reproducing apparatus and the mobile phone conversation apparatus being configured to communicate with each other via a first wireless communication, the mobile phone conversation apparatus and the server device being configured to communicate with each other via a second wireless communication and the Internet, the second wireless communication being different from the first wireless communication in signal mode,
the music reproducing apparatus, the mobile phone conversation apparatus, and the server device each comprising a control section configured to control the mobile phone conversation apparatus so as to:
make a display on a display screen based on a folder structure of a plurality of files in the mobile phone conversation apparatus when the folder structure of the plurality of files which conform to a digital voice file format recorded in a recording section of the music reproducing apparatus is supplied to the mobile phone conversation apparatus via the first wireless communication;
in response to the display, acquire from the server device via the second wireless communication and the Internet, lyrics information according to a predetermined file when a user instructs a command for reproducing the predetermined file via an operating section of the mobile phone conversation apparatus;
transmit the predetermined file and the reproducing command to the music reproducing apparatus via the first wireless communication;
display the acquired lyrics information in the mobile phone conversation apparatus, and
reproduce the predetermined file contained in the music reproducing apparatus.

17. A method for operating a music reproducing apparatus using a mobile phone conversation apparatus of the music reproducing apparatus, the method comprising the steps of:
the music reproducing apparatus carrying out an authenticating process with respect to the mobile phone conversation apparatus;
when the authentication process is successful, transmitting to the mobile phone conversation apparatus, operating information including a folder structure of a plurality of files which conforms to at least a digital voice file format which the music reproducing apparatus records; and
upon receipt of a reproducing command having specified one of the plurality of files from the mobile phone conversation apparatus, reading out, decompressing, and reproducing the file.

18. The operating method according to claim 17, wherein, upon receipt of a call arrival signal from the mobile phone conversation apparatus, in response to the call arrival signal, each section is controlled so as to cancel reproduction of a file which conforms to a digital voice file format which is currently reproduced or reduce a volume, and then, to notify to a user that the call arrival has occurred by means of a voice or another method.

19. The operating method according to claim 17, wherein, upon receipt of a call arrival signal and a signal indicating a telephone number of the call arrival from the mobile phone conversation apparatus, in response to these signals, each section is controlled so as to cancel reproduction of a file which conforms to a digital voice file format which is currently reproduced or reduce a volume, and then, reproduce the file which conforms to the digital voice file format according to the telephone number, thereby notifying to a user that the call arrival has occurred.

20. A method for operating an information reproducing system having a music reproducing apparatus, a mobile phone conversation apparatus, and a server device, the music reproducing apparatus and the mobile phone conversation apparatus being configured to communicate with each other via a first wireless communication, the mobile phone conversation apparatus and the server device being configured to communicate to each other via a second wireless communication and the Internet, the second wireless communication being different from the first wireless communication in signal mode, the method comprising:
making a display on a display screen based on a folder structure of a plurality of files in the mobile phone conversation apparatus when the folder structure of the plurality of files which conform to a digital voice file format recorded in a recording section of the music reproducing apparatus is supplied to the mobile phone conversation apparatus via the first wireless communication;
in respect to the display, acquiring from the server device via the second wireless communication and the Internet, lyrics information according to a predetermined file when a user instructs a command for reproducing the predetermined file via an operating section of the mobile phone conversation apparatus;
displaying the acquired lyrics information on a display screen, and then, transmitting the predetermined file and the reproducing command to the music reproducing apparatus via the first wireless communication in the mobile phone conversation apparatus, thereby reproducing the predetermined file contained in the music reproducing apparatus.
